(19) United States
(12) Patent Application Publication
(10) Pub. No.: US 2026/0261552 A1
(43) Pub. Date: Sep. 3, 2026

(54) SEAMLESS USER AUTHENTICATION IN MULTI-CLOUD ZERO-TRUST ARCHITECTURES USING SELF-SUPERVISED LEARNING

(71) Applicant: DELL PRODUCTS L.P., Round Rock, TX (US)

(72) Inventors: Avinash Kumar, Patna (IN); Parminder Singh Sethi, Ludhiana (IN); Praveen Kumar, Noida (IN)

(21) Appl. No.: 19/067,960

(22) Filed: Mar. 2, 2025

(51) Int. Cl. H04L 9/40; H04L 41/16

(52) U.S. Cl. CPC H04L 63/083; H04L 41/16; H04L 63/102

(57) ABSTRACT

An information handling system includes a memory device to store code and a processor to execute code. The processor receives behavior information from a user environment, instantiates a machine learning model to evaluate the behavior information to determine if the behavior information matches authenticated behavior, and authenticates the user environment to utilize a protected element of the information handling system in response to determining that the behavior information matches the authenticated behavior.

### FIELD OF THE DISCLOSURE

This disclosure relates to information handling systems, and more particularly relates to providing a seamless user authentication in a multi-cloud zero-trust architectures using self-supervised learning in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include a memory device to store code and a processor to execute code. The processor may receive behavior information from a user environment, instantiate a machine learning model to evaluate the behavior information to determine if the behavior information matches authenticated behavior, and authenticate the user environment to utilize a protected element of the information handling system in response to determining that the behavior information matches the authenticated behavior.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagrams illustrating an information handling system according to various embodiments of the present disclosure; and

FIG. 2 is a block diagram illustrating a generalized information handling system according to another embodiment of the present disclosure;

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

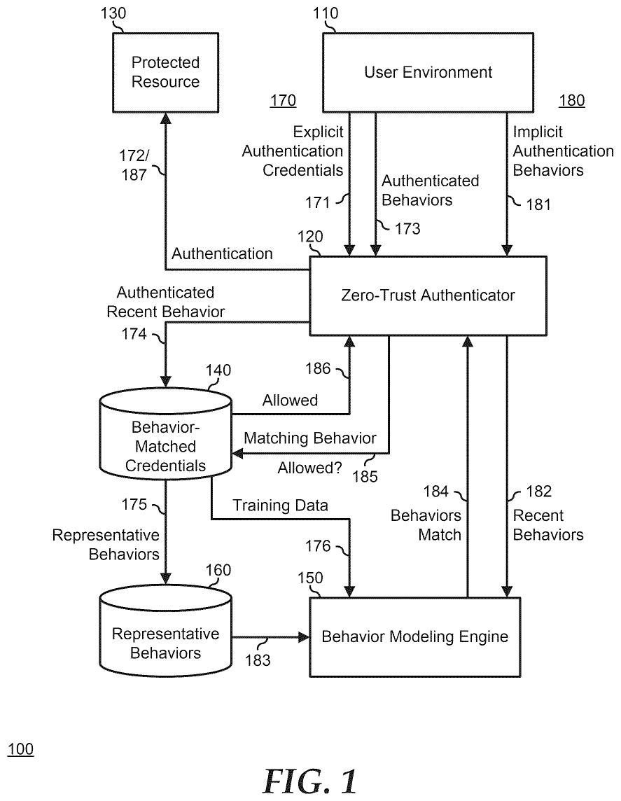

FIG. 1 illustrates an information handling system 100 including a user environment 110, a zero-trust authenticator 120, a protected resource 130, a behavior-matched credential repository 140, a behavior modeling engine 150, and a representative behaviors repository 160. Information handling system 100 represents a system configured to implement a zero-trust architecture. In particular, information handling system 100 implements a security policy that assumes all users, devices, networks, operating environments, applications, workloads, and the like are untrusted by default, even when such elements are a part of a trusted environment. The zero-trust architecture is implemented by establishing identity verification, validating device compliance prior to granting access, and ensuring least privilege access to only explicitly-authorized resources.

It has been understood by the inventors of the current disclosure that modern computing environments typically consist of many interconnected zones, cloud services, infrastructure, connections to remote and mobile environments, and connections to non-conventional resources such as Internet-of-Things devices. In this regard, the zero-trust architecture will be understood to reduce the risk of unauthorized access to the resources of the environment, it introduces frequent authentication requests that can disrupt the user experience. This challenge is only increased in multi-cloud environments, where users interact with different cloud services requiring separate authentications.

User environment 110 represents a computer device, such as a laptop computer or mobile computing device like a smartphone or tablet device, a desktop or workstation computer, a slim client device, or a remote processing environment instantiated on such a device or computer. User environment 110 is characterized by the fact that the user environment can utilize one or more protected resource, such as protected resource 130. Protected resource 130 represents an element of hardware, software, firmware or the like that is protected from unauthorized access by zero-trust authenticator 130. User environment 110 provides authentication credentials to zero-trust authenticator 120 to gain access to protected resource 130. The elements of information handling system 100 (user environment 110, zero-trust authenticator 120, protected resource 130, behavior-matched credential repository 140, behavior modeling engine 150, and representative behaviors repository 160) may be understood to be located in any desired location, as needed or desired. For example, the elements may be included as elements of user environment 110, may be located remotely from the user environment, or may be located partially as elements of the user environment and partially remotely from the user environment, as needed or desired. In a particular embodiment, the elements of information handling system 100 other than user environment 110 may be located as resources that are available to the user environment in a cloud or as a remote server that is available to a remote desktop environment instantiated on the user environment, as needed or desired.

Zero-trust authenticator 120 operates to provide the authentication of the users, devices, networks, operating environments, applications, workloads, and the like for information handling system 100. In particular, zero-trust authenticator 120 represents a hardware device, firmware, software, or the like configured to authenticate user environment 110 to utilize protected resource 130. The details of implementing a zero-trust architecture are known in the art and will not be further described herein, except as may be needed to illustrate the current embodiments. Behavior-matched credential repository 140, behavior modeling engine 150, and a representative behaviors repository 160 will be described further below.

In a particular embodiment, information handling system 100 operates to provide a two-tiered authentication scheme, including an explicit authentication method 170, as illustrated by method steps 171-176, and an implicit authentication 180, as illustrated by method steps 181-187. In explicit authentication method 170, a user of user environment 110 provides explicit authentication credentials 171 to zero-trust authenticator 120. The provision of explicit authentication credentials 170 will be understood to be provided in order for the user to access protected resource 130, but this is not necessarily so, and the authentication credentials may be for provided for authenticate to any combination of users, devices, networks, operating environments, applications, workloads, and the like that are default-untrusted on information handling system 100, as needed or desired. Explicit authentication credentials 121 may be provided in response to a prompt provided by zero-trust authenticator 120 to user environment 110. Such a prompt may include a single-factor authentication, such as a request for a username/password combination, a two-factor authentication, such as verification code in addition to a username/password combination, or any other type of explicit authentication activity as may be known in the art. Such a prompt may in turn be in response to an access request by user environment 110 to protected resource 130, as needed or desired.

In step 172, zero-trust authenticator 120 provides authenticated access to protected resource 130 in response to authenticating explicit authentication credentials 171. Here, it may be assumed that explicit authentication credentials 171 were in fact authenticated by zero-trust authenticator 120, and it will be understood that no access is granted to protected resource 130 if the explicit authentication credentials were not authenticated by the zero-trust authenticator. Once explicit authentication credentials 171 are authenticated, user environment 110 provides a stream of authenticated behaviors 172 to zero-trust authenticator 120. Authenticated behaviors 137 represent actions taken on user environment 110 in utilizing protected resource 130. For example, where protected resource 130 represents a protected file or volume on a data storage device and the authenticated user represents a office productivity worker on information handling system 100, it may be common for the authenticated user to read the file or volume, the authenticated user may occasionally modify the file or volume, the authenticated user may rarely delete the file or volume, and the authenticated user may never have encrypted the file or volume. More broadly, the authenticated user may be understood from authenticated behavior 173 to never change configuration settings on protected resource 130. For another user, such as a service technician on information handling system, the opposite conditions may apply, where the service technician seldom edits or deletes a file or volume, but normally manages the configuration settings on protected resource 130. In another example, authenticated behaviors 173 may represent more personal behavior information as may be received based upon a keystroke logger, a camera/video device, a microphone, or the like, or the pattern of applications routinely utilized by the authenticated user. For example, the authenticated user's web browsing patterns and habits may be provided as authenticated behaviors 173, as needed or desired.

In a next step, zero-trust authenticator 120 tags the behavior with the authentication information for the associated user, and provides the authenticated recent behavior 174 to behavior-matched credential repository 140. In a particular embodiment, behavior-matched credential repository 140 is remote from user environment 110, such as in a secure external database. The tags to authenticated recent behavior 174 may include the levels of authenticated access and privilege that is granted to the authenticated user, but may exclude explicit authentication credentials 171, in order to avoid the risk of distributing such credentials outside of zero-trust authenticator 120, as needed or desired. In a particular embodiment, zero-trust authenticator 120 abstracts authenticated behaviors 173 for retention in behavior-matched credential repository 140 to allow for quick recognition of the authenticated user without exposing sensitive information. Here, it may7 be understood that behavior-matched credential repository 140 will be provided with authenticated recent behavior 174 from a wide variety of authenticated users and from multiple user environments similar to user environment 110, as needed or desired. In this way behavior-matched credential repository 140 may provide a rich data set for training behavior modeling engine 150 as described further below.

In a next step, behavior-matched credential repository 140 provides representative behaviors 175 to representative behaviors repository 160. In particular, behavior-matched credential repository 175 abstracts authenticated recent behavior 174 and the authenticated recent behavior from other users and user environments, to provide a database of behaviors that are associated with authenticated behavior, and the types of authentication levels and access privileges that are correlated to the representative behavior. Representative behavior repository 160 is utilized in implicit authentication 180, as described further below.

Finally behavior-matched credential repository 140 forwards authenticated recent behavior 174 and the authenticated recent behavior from other users and user environments to behavior modeling engine 150 as training data 176. Here, behavior modeling engine 150 represents a machine learning algorithm that operates to determine whether two sets of behavior (recent behaviors 182 from zero-trust authenticator 120, and representative behavior 183 from representative behavior repository 160), belong to a common authenticated user with common access permissions, as described further below. In a particular embodiment, behavior modeling engine 150 represents a self-supervised learning (SSL) machine learning model that is trained utilizing training data 176 to recognize patterns and anomalies in user behavior, and to learn to identify whether a current behavior sequence matches a previously authenticated entity. For example, behavior modeling engine 150 may utilize a contrastive learning algorithm to improve the model's ability to distinguish between different entities based on their behavior sequences, ensuring accurate and efficient implicit authentication, as described further below.

In implicit authentication method 180, no explicit authentication is provided as described above. Here, instead, the user behavior on user environment 110 is utilized to authenticate the user without the user or the user environment having to provide explicit authentication credentials 171. Here, it will be understood that zero-trust authenticator 120 may have provided a request for authentication from user environment 110. For example, a time window associated with the initial authentication may have expired, a user may have temporarily left the vicinity of the user environment, or other needs for reauthentication may have been identified that would otherwise require the user to provide explicit authentication credentials 171 again. In this case, implicit authentication behaviors 181 are provided by user environment 110 to zero-trust authenticator 120. Implicit authentication behaviors 181 are similar to explicit authentication behaviors 171, except that here the implicit authentication behaviors are not specifically tagged as being associated with an authenticated user.

Instead, in a next step, zero-trust authenticator 120 provides recent behaviors 182 (i.e., implicit authentication behaviors 181) to behavior modeling engine 150. Then behavior modeling engine 150 receives representative behaviors 183 from representative behavior repository 160 to determine whether a current behavior sequence matches a previously authenticated entity If the behavior sequence (i.e., recent behaviors 182) matches the previously authenticated entity (i.e., representative behaviors 183), then behavior modeling engine 150 provides an indication that the behaviors match to zero-trust authenticator 120 in step 184.

When zero-trust authenticator 120 receives matching behaviors indicator 184, the zero-trust authenticator provides a query to behavior-matched credential repository 140 as to whether or not the matching behavior is allowed in step 185. In a next step, behavior-matched credential repository 140 provides a query to determine if the matching behavior is associated with a credentialed (i.e., allowed) user, and if so, the behavior-matched credential repository provides an indication 186 back to zero-trust authenticator 120 that the matching behaviors are associated with a credentialed user. In a particular case, the matching behavior query 185 is tagged with a user associated with implicit authentication behaviors 181, and behavior-matched credential repository 140 determines if the matching behavior is associated with the same user as provided the implicit authentication behaviors. When zero-trust authenticator 120 receives allowed user indication 186, the zero-trust authenticator provides authenticated access 187 to protected resource 130 in response to authenticating explicit authentication credentials 181. In this way, implicit authentication 180 enables a seamless authentication experience for the user that significantly reduces the frequency of explicit authentication requests, thereby providing a smoother user experience while maintaining the zero-trust security model on information handling system 100.

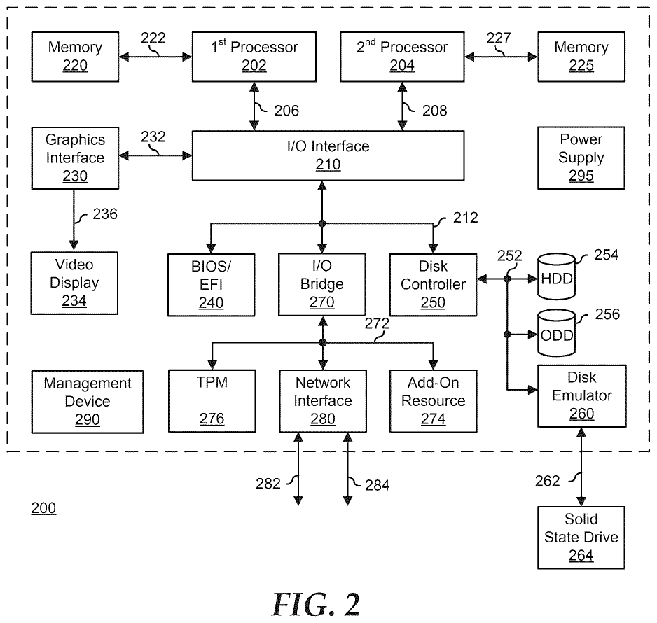

FIG. 2 illustrates a generalized embodiment of an information handling system 200 similar to information handling system 200. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 200 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 200 can include processing resources for executing machine-executable code, such as a central processing unit (CPU), a programmable logic array (PLA), an embedded device such as a System-on-a-Chip (SoC), or other control logic hardware. Information handling system 200 can also include one or more computer-readable medium for storing machine-executable code, such as software or data. Additional components of information handling system 200 can include one or more storage devices that can store machine-executable code, one or more communications ports for communicating with external devices, and various input and output (I/O) devices, such as a keyboard, a mouse, and a video display. Information handling system 200 can also include one or more buses operable to transmit information between the various hardware components.

Information handling system 200 can include devices or modules that embody one or more of the devices or modules described below, and operates to perform one or more of the methods described below. Information handling system 200 includes a processors 202 and 204, an input/output (I/O) interface 210, memories 220 and 225, a graphics interface 230, a basic input and output system/universal extensible firmware interface (BIOS/UEFI) module 240, a disk controller 250, a hard disk drive (HDD) 254, an optical disk drive (ODD) 256, a disk emulator 260 connected to an external solid state drive (SSD) 262, an I/O bridge 270, one or more add-on resources 274, a trusted platform module (TPM) 276, a network interface 280, a management device 290, and a power supply 295. Processors 202 and 204, I/O interface 210, memory 220, graphics interface 230, BIOS/UEFI module 240, disk controller 250, HDD 254, ODD 256, disk emulator 260, SSD 262, I/O bridge 270, add-on resources 274, TPM 276, and network interface 280 operate together to provide a host environment of information handling system 200 that operates to provide the data processing functionality of the information handling system. The host environment operates to execute machine-executable code, including platform BIOS/UEFI code, device firmware, operating system code, applications, programs, and the like, to perform the data processing tasks associated with information handling system 200.

In the host environment, processor 202 is connected to I/O interface 210 via processor interface 206, and processor 204 is connected to the I/O interface via processor interface 208. Memory 220 is connected to processor 202 via a memory interface 222. Memory 225 is connected to processor 204 via a memory interface 227. Graphics interface 230 is connected to I/O interface 210 via a graphics interface 232, and provides a video display output 236 to a video display 234. In a particular embodiment, information handling system 200 includes separate memories that are dedicated to each of processors 202 and 204 via separate memory interfaces. An example of memories 220 and 230 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 240, disk controller 250, and I/O bridge 270 are connected to I/O interface 210 via an I/O channel 212. An example of I/O channel 212 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 210 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 240 includes BIOS/UEFI code operable to detect resources within information handling system 200, to provide drivers for the resources, initialize the resources, and access the resources. BIOS/UEFI module 240 includes code that operates to detect resources within information handling system 200, to provide drivers for the resources, to initialize the resources, and to access the resources.

Disk controller 250 includes a disk interface 252 that connects the disk controller to HDD 254, to ODD 256, and to disk emulator 260. An example of disk interface 252 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 260 permits SSD 264 to be connected to information handling system 200 via an external interface 262. An example of external interface 262 includes a USB interface, an IEEE 1394 (Firewire) interface, a proprietary interface, or a combination thereof. Alternatively, solid-state drive 264 can be disposed within information handling system 200.

I/O bridge 270 includes a peripheral interface 272 that connects the I/O bridge to add-on resource 274, to TPM 276, and to network interface 280. Peripheral interface 272 can be the same type of interface as I/O channel 212, or can be a different type of interface. As such, I/O bridge 270 extends the capacity of I/O channel 212 where peripheral interface 272 and the I/O channel are of the same type, and the I/O bridge translates information from a format suitable to the I/O channel to a format suitable to the peripheral channel 272 where they are of a different type. Add-on resource 274 can include a data storage system, an additional graphics interface, a network interface card (NIC), a sound/video processing card, another add-on resource, or a combination thereof. Add-on resource 274 can be on a main circuit board, on separate circuit board or add-in card disposed within information handling system 200, a device that is external to the information handling system, or a combination thereof.

Network interface 280 represents a NIC disposed within information handling system 200, on a main circuit board of the information handling system, integrated onto another component such as I/O interface 210, in another suitable location, or a combination thereof. Network interface device 280 includes network channels 282 and 284 that provide interfaces to devices that are external to information handling system 200. In a particular embodiment, network channels 282 and 284 are of a different type than peripheral channel 272 and network interface 280 translates information from a format suitable to the peripheral channel to a format suitable to external devices. An example of network channels 282 and 284 includes InfiniBand channels, Fibre Channel channels, Gigabit Ethernet channels, proprietary channel architectures, or a combination thereof. Network channels 282 and 284 can be connected to external network resources (not illustrated). The network resource can include another information handling system, a data storage system, another network, a grid management system, another suitable resource, or a combination thereof.

Management device 290 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 200. In particular, management device 290 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 200, such as system cooling fans and power supplies. Management device 290 can include a network connection to an external management system, and the management device can communicate with the management system to report status information for information handling system 200, to receive BIOS/UEFI or system firmware updates, or to perform other task for managing and controlling the operation of information handling system 200. Management device 290 can operate off of a separate power plane from the components of the host environment so that the management device receives power to manage information handling system 200 where the information handling system is otherwise shut down. An example of management device 290 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 290 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed:

1. An information handling system, comprising:
a memory device to store code; and
a processor to execute code, the processor configured to receive behavior information from a user environment, to instantiate a machine learning model to evaluate the behavior information to determine if the behavior information matches authenticated behavior, and authenticate the user environment to utilize a protected element of the information handling system in response to determining that the behavior information matches the authenticated behavior.

2. The information handling system of claim 1, wherein the processor is further configured to instantiate a zero-trust authenticator module configured to receive a first indication from the machine learning model when the behavior information matches the authenticated behavior.

3. The information handling system of claim 2, wherein the zero-trust authenticator module authenticates the user environment to utilize the protected element in response to receiving the first indication.

4. The information handling system of claim 2, wherein the zero-trust authenticator module is further configured to receive a second indication from the machine learning model when the behavior information does not match the authenticated behavior.

5. The information handling system of claim 4, wherein the zero-trust authenticator module is further configured prompt the user environment to provide authentication credentials for the protected resource in response to receiving the second indication.

6. The information handling system of claim 1, wherein, prior to receiving the behavior information, the processor is further configured to receive authentication credentials from the user environment, to authenticate the user environment to utilize the protected element in response to receiving the authentication credentials, and to receive the authenticated behavior from the user environment in response to authenticating the user environment to utilize the protected element.

7. The information handling system of claim 6, wherein the processor is further configured to tag the authenticated behavior as being associated with the authentication credentials.

8. The information handling system of claim 7, wherein the processor is further configured to provide the tagged authenticated behavior to train the machine learning model.

9. The information handling system of claim 1, wherein the machine learning model includes a self-supervised learning model.

10. The information handling system of claim 9, wherein the self-supervised learning model utilizes a contrastive learning algorithm.

11. A method, comprising:
receiving, by a processor of an information handling system, behavior information from a user environment of the information handling system;
instantiating, by the processor, a machine learning model;
evaluating, by the machine learning model, the behavior information to determine if the behavior information matches authenticated behavior;
authenticating the user environment to utilize a protected element of the information handling system in response to determining that the behavior information matches the authenticated behavior.

12. The method of claim 11, further comprising:
instantiating, by the processor, a zero-trust authenticator module; and
receiving, by the zero-trust authenticator module, a first indication from the machine learning model when the behavior information matches the authenticated behavior.

13. The method of claim 12, further comprising:
authenticating, by the zero-trust authenticator module, the user environment to utilize the protected element in response to receiving the first indication.

14. The method of claim 12, further comprising:
receiving, by the zero-trust authenticator module, a second indication from the machine learning model when the behavior information does not match the authenticated behavior.

15. The method of claim 14, further comprising:
prompting, by the zero-trust authenticator module, the user environment to provide authentication credentials for the protected resource in response to receiving the second indication.

16. The method of claim 11, wherein, prior to receiving the behavior information, the method further comprises:
receiving, by the processor, authentication credentials from the user environment;
authenticating the user environment to utilize the protected element in response to receiving the authentication credentials; and
receiving the authenticated behavior from the user environment in response to authenticating the user environment to utilize the protected element.

17. The method of claim 16, further comprising:
tagging, by the processor, the authenticated behavior as being associated with the authentication credentials.

18. The method of claim 17, further comprising:
providing, by the processor, the tagged authenticated behavior to train the machine learning model.

19. The method of claim 11, wherein the machine learning model includes a self-supervised learning model, wherein the self-supervised learning model utilizes a contrastive learning algorithm.

20. An information handling system, comprising:
a protected element;
a memory device to store code; and
a processor to execute code, the processor configured to receive behavior information from a user environment, to instantiate a machine learning model to evaluate the behavior information to determine if the behavior information matches authenticated behavior, and authenticate the user environment to utilize the protected element of the information handling system in response to determining that the behavior information matches the authenticated behavior.
